(19) United States
(12) Patent Application Publication
(10) Pub. No.: US 2011/0231416 A1
(43) Pub. Date: Sep. 22, 2011

(54) Analyzing script for scanning mass internet content

(76) Inventor: Brandon Lee Goodchild Drake, Albuquerque, NM (US)

(21) Appl. No.: 12/661,743

(22) Filed: Mar. 22, 2010

(51) Int. Cl. G06F 17/30

(52) U.S. Cl. 707/754; 707/E17.059; 707/E17.014

(57) ABSTRACT

Disclosed is a method, system, and process of analyzing script for scanning mass internet content, comprising news websites, blogs, social media sites, and other forms of internet-based content posted online by separate users and organizations. The script is arrayed in filter modules and performs staged, multiple keyword searching and collects/assigns opinion, temporal, and geographic information to create individual synthetic units. These synthetic units can be displayed in a variety of ways including as geospatial maps, timelines, and in a variety of more advanced analytical charts. The filter modules are easily replicated and represent a flexible and powerful data collection and processing tool. The script allows for rapid and massive content analysis online and the preparation of synthetic units for display to interested parties.

### BACKGROUND OF THE INVENTION

1. Technical Field of the Invention

A script scans mass internet content; comprising news websites, blogs, social media sites, and other forms of internet-based content posted online by separate users and organizations. The script first enters a search term, and then scans the output for additional key terms. It then categorizes each result based on the secondary searches, producing data for the proportion of general views in the search. The script is automated and runs in regular, fixed time intervals, producing data that can be used to illustrate trends and produce output for advanced statistical analysis. The results are displayed as both charts and geospatial maps. These are then displayed alongside qualitative analysis.

2. Description of the Prior Art

The Internet as we know it today was born on Jan. 1, 1983, and brought to universities by the National Science Foundation in 1985. The subsequent creation of the World Wide Web in the early 1990's spurred an explosion of textual data. Since then it has experienced near astronomical growth, as of this writing a quarter of the world's population enjoy the services of the internet.

With this growth is an explosion in the data and information that is exchanged on the interne. There are over 550 billion documents stored within the web, at least 25.21 billion were indexable as of March 2009. In July of 2008, Google announced that 1 trillion unique url's had been identified.

The growth of social media networks in the past decade has surpassed any expectations at the outset of the millennium. Facebook, with 350 million users, is now more populous than the United States. Twitter, with 18 million users, is approaching the size of Australia's population. The dramatic rise in social media has opened up a flood of data. For example, Twitter currently produces 3 million tweets a day and experienced 1,300% growth in March of 2009. The growth of data outpaces the ability of interested parties to keep up with the new mediums, and results in either disengaged or sub-optimal presence on these new networks.

A company seeking to tap into this vast content to identify positive or negative reception to a new product or service faces challenges on several fronts. First, they have to identify what portions of the web are needed sources of information; are these on social media networks, blogs, news paper comments? Second, they have to read through the large loads of relevant media to find the portions relevant to them. Finally, the data must be compiled in a way that can yield useful results.

Much of the dialogue in websites, blogs, and social media is directly relevant to politicians, corporations, and special interest groups. On Twitter upwards of 1 million tweets a day are of interest to various parties with a stake in a particular point of view. Social media networks provide valuable feedback that can help inform many people, but there is a clear deficiency in getting hold of the massive growth in this communication. For interested parties to gain a foothold in this changing environment, a set of tools is needed to filter what is relevant and produce metrics.

A key problem many face is making the process more efficient. In order to get a good representation of the attitudes of various parties, a large amount of data is needed as small cursory searches will be tied to high uncertainty. While some may enjoy wading through hundreds/thousands of tweets to get a sense of what people are saying, most would prefer a quick summation of data that save time and gets to the point. This includes giving them the relevant information, as well as bringing together graphs that help the end user better understand the relationships occurring online. One of the most valuable resources to companies and campaigns alike is time, and any method that can reduce the noise and present a clear picture of the online conversation will help meet the bottom line.

U.S. Pat. No. 4,930,077 issued to Fan on May 29, 1990 for a method and system of text analysis was able to determine author position on an issue or set of specific issues. The system executes an algorithm to assess position on a specific issue with a human operator. Over time, this can be used to identify trends in public opinion on specific issues when executed with due diligence.

This reference is deficient with respect to the present invention in that this system is a) dependent upon a human operator for execution, b) focused on polling data, rather than other forms of media and c) insufficiently modular and/or flexible to be easily replicated to accommodate massive amounts of data. The practicality of text analysis increases with the volume of material studied and the flexibility to adapt the software to meet new needs.

U.S. Pat. No. 7,668,791 issued to Azzam et al. on Feb. 23, 2010 discloses a computer implemented method for distinguishing facts from opinions. The method employs a standing list of words associated with factual statements to test against electronic documents to differentiate between fact and opinion. Further analysis utilizes linguistic clues in the syntax to better categorize the electronic statement.

This reference is deficient with respect to the present invention in that this method is focused on distinguishing fact from opinion, rather than eliciting the diversity of data within the category of “opinion”. The ability to employ keyword analysis and syntax placement is critical, however the ability to cull data specific to individual clients adds a dimension to the concept that makes it directly applicable to more parties.

United States Patent publication number 2009/0319436 A1 published Dec. 24, 2009 by Andra et al. discloses a method, a system, and an apparatus of opinion analysis and recommendations in social media platforms. Attributes of opinion data are analyzed using a natural language processing algorithm to determine the opinion match of a user. This is used to connect a user with other users expressing the same opinion on the platform, and help calibrate/target advertising based on the concept.

This reference is deficient with respect to the present invention in that it focuses on connecting social media platform users and generating data to better target advertising. The potential to do long-term and detailed analytics custom built around specific queries presents a rich opportunity to combine

U.S. Pat. No. 7,647,321 issued to Lund et al. on Jan. 12, 2010 for systems and methods for use in filtering electronic messages using business heuristics. The system scans incoming electronic messages to determine the desirability of the business, and assigns a spam score based on the disclosed method. The message may be blocked if it is deemed unsuitable to the recipient.

This reference is deficient with respect to the present invention in that this system looks at electronic messages rather than web content, and in that it is intended as a spam filter. The principle of heuristic analysis is currently underutilized in automated text analysis, and is suited for rich expansion in to World Wide Web and additional interne content.

U.S. Pat. No. 7,660,783 issued to Reed on Feb. 9, 2010 for a computer implemented method of performing an ad-hoc analysis including the steps of: generating a text index of the textual information items, generating a metadata lookup structure based, at least in part, on the text index, searching the text index using a search query, compiling results of the text index search into aggregate information related to characteristics of the search results from the metadata items associated with the textual information items in the search results from the metadata lookup structure, and reporting the aggregate information. The application of the method results in a search that provides summary information that is more time efficient than simple web searching.

This reference is deficient with respect to the present invention in that this system is that it looks at volume and identifies demographic trends—it does not attempt to classify opinion data or determine the tone of the message.

U.S. Pat. No. 7,660,822 issued to Pfleger on Feb. 9, 2010 for systems and methods for sorting and displaying search results in multiple dimensions discloses a system that plots results of a data search. The system executes one or more search queries to search stored data. The system receives results of the executed one or more search queries, where the results are orderable by at least one search characteristic. The system designates a visual representation for each of the results. The system plots each of the visual representations on a multi-dimensional graphical display, where at least one dimension of the multi-dimensional graphical display corresponds to the at least one search characteristic.

This reference is deficient with respect to the present invention in that this system is aimed toward displaying search results based on individual user input. The invention disclosed in this application aims at displaying information regarding tone in a geospatial map.

United States Patent publication number 2009/0319518 A1 published Dec. 24, 2009 by Koudas and Bansal for a method for searching text sources including temporally ordered data objects, such as a blog includes the steps of: (i) providing access to text sources, each text source including temporally-ordered data objects; (ii) obtaining or generating a search query based on terms and time intervals; (iii) obtaining or generating time data associated with the data objects; (iv) identifying data objects based on the search query; and (v) generating popularity curves based on the frequency of data objects corresponding to one or more of the search terms in the one or more time intervals. Blog posts are analyzed based on keywords and the data is displayed in a number of embodiments including time trends and spatial display of the data.

This reference is deficient with regard to the present invention in that this method assesses the output over time for given key words, rather than assess the tone of the message. It also focuses exclusively upon the blogosphere, rather than extend either to traditional media (i.e. news/information sites) or social media (Twitter, Facebook, etc.).

### 3. SUMMARY OF THE INVENTION

A script scans internet content search output; web content being content posted online by separate users. The script first enters a search term, and then scans the output for secondary key terms. It then categorizes each result based on the secondary searches, producing data for the proportion of general views in the search. A variety of analytical techniques are employed to categorize and compile the data into synthetic units. The script is automated and runs in regular, fixed time intervals, producing data that can be used to illustrate trends and be displayed as summary data or in a geospatial map.

It is an object of the present invention to rapidly scan massive amounts of textual data in regular time intervals to produce data sets that can be used to monitor media coverage of specific issues. When run and analyzed in regular time intervals, the invention will generate synthetic units that can be used to identify areas of concern where opinion on a given issue is swaying one way or another.

It is another object of the present invention to use advanced statistical methods to use the information gathered from content analysis to identify trends, clusters, correlations, and other statistically significant factors. This processed data can then be used to display information clearly through charts, graphs, or maps. In one preferred embodiment, the data is displayed geospatially in three dimensions, with different areas of a given region identified by color and altitude based on opinion and volume of content. In another preferred embodiment, this display could be simplified to a simple 2 dimensional display using only colors to identify either volume or opinion.

It is another object of the invention to couple the invention with a consulting service aimed at providing detailed advice with regard to the interpretation of the data analysis. This includes qualitative assessment alongside the quantitative methods disclosed in this patent, and may include text and video analysis.

It will therefore be seen by a careful review of this application including the drawings that the present invention provides the one having it with great advantages in the use of the present invention which is only limited by the scope of the appending claims herein below.

### 4. BRIEF DESCRIPTION OF THE DRAWINGS

FIG. 1A illustrates how social media is “nested” in the internet at large, and it's relationships with various sites.

FIG. 1B illustrates the role of news/blog sites in the internet at large, and it's relationships with various other types of sites.

FIG. 1C illustrates an x-y curve of diminishing returns for the relationship between return and investment on interactions with social media.

FIG. 2 illustrates the function of the module, including the steps of parsing, analyzing, and compiling the data into a synthetic datum.

FIG. 3A illustrates a system of using online search pages to pull and categorize data with modular filters from social media.

FIG. 3B illustrates the replication of modules with modification from a central server with regard to social media.

FIG. 3C illustrates a system of using online search pages to pull and categorize data with modular filters from news/blog sites.

FIG. 3D illustrates the replication of modules with modification from a central server with regard to news/blog sites.

FIG. 4A illustrates the process the replication of the filter module from a central server in the context of social media pages.

FIG. 4B illustrates the process of replication of the filter module from a central server in the context of news pages and blogs.

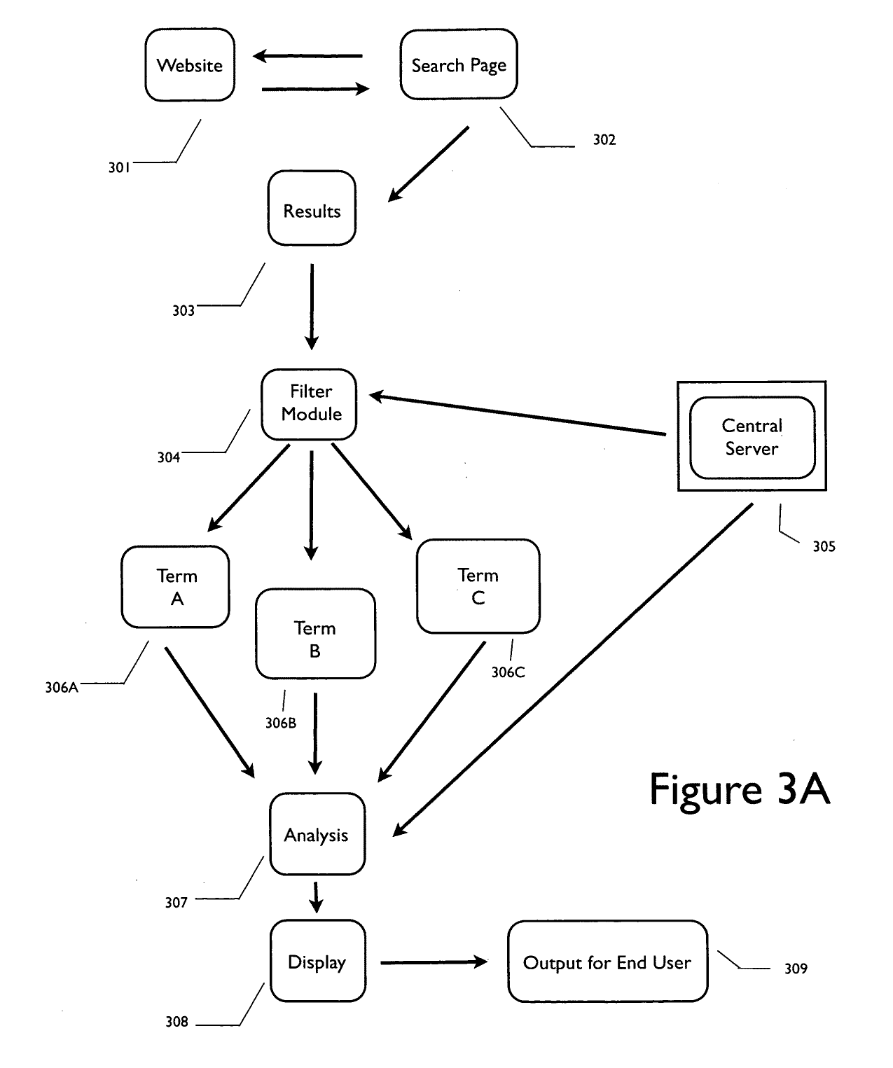

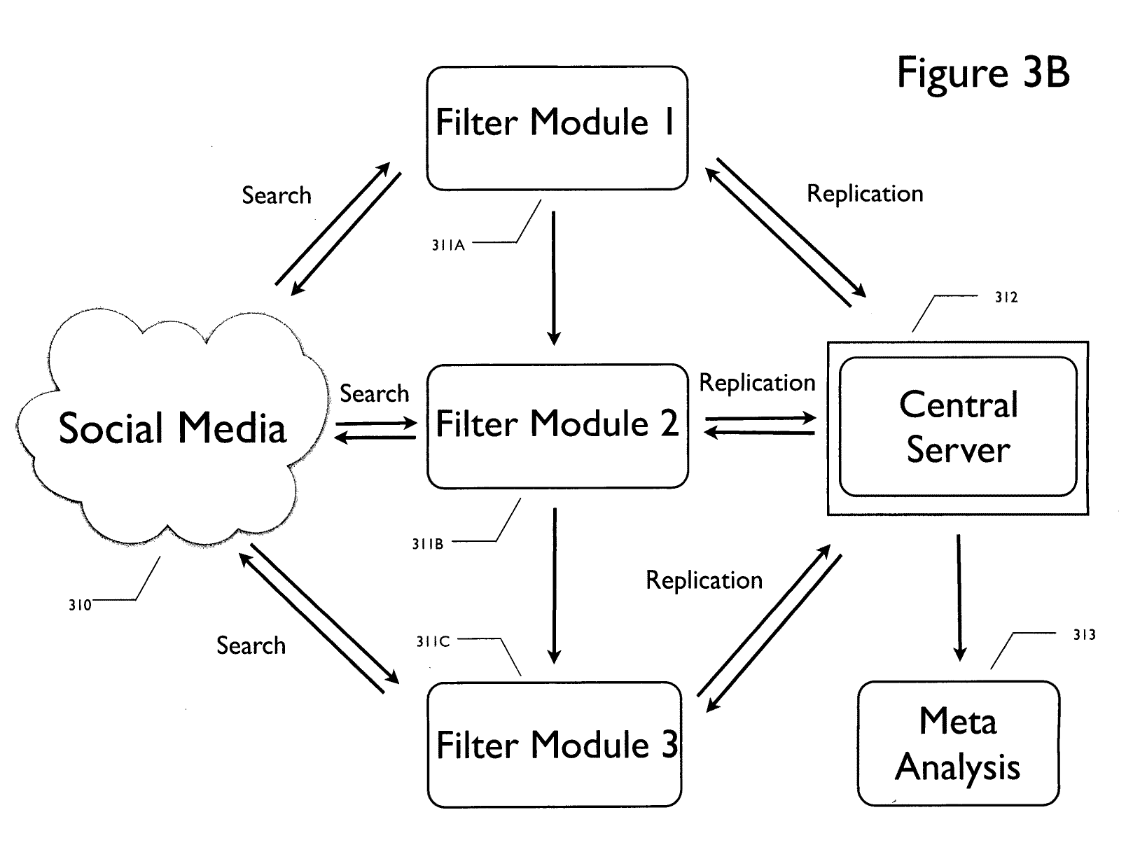

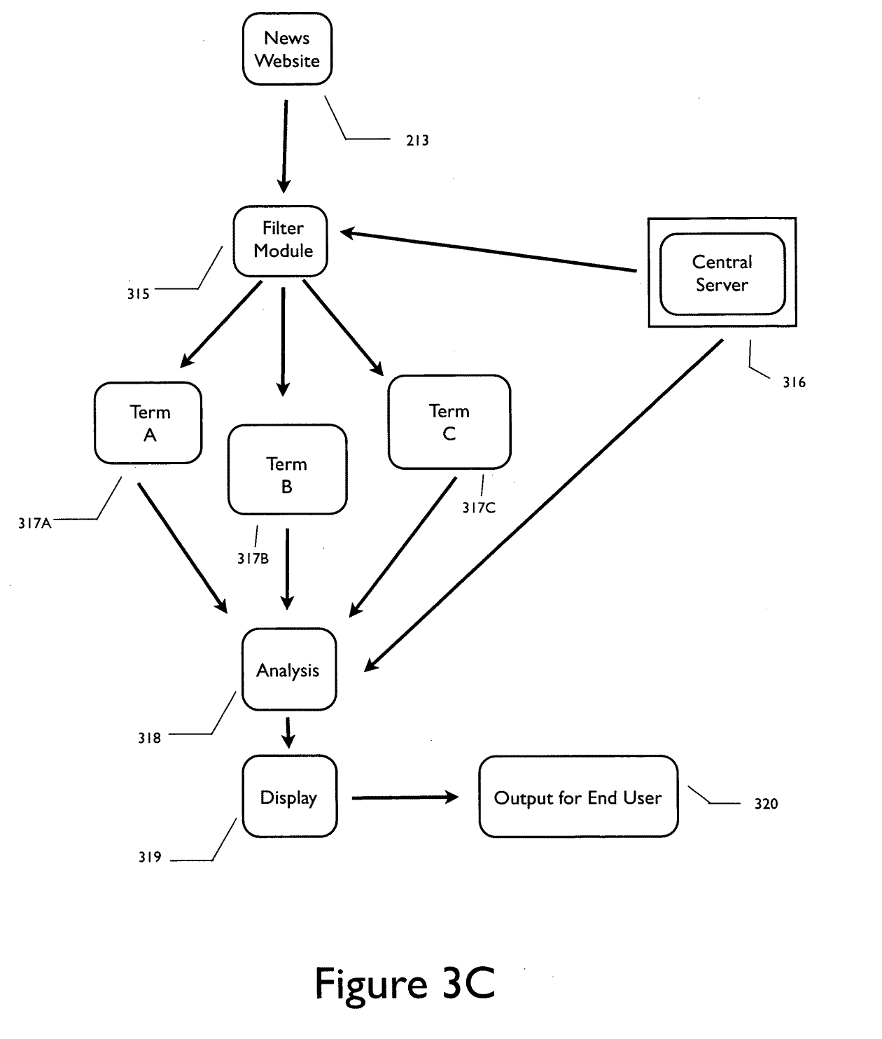

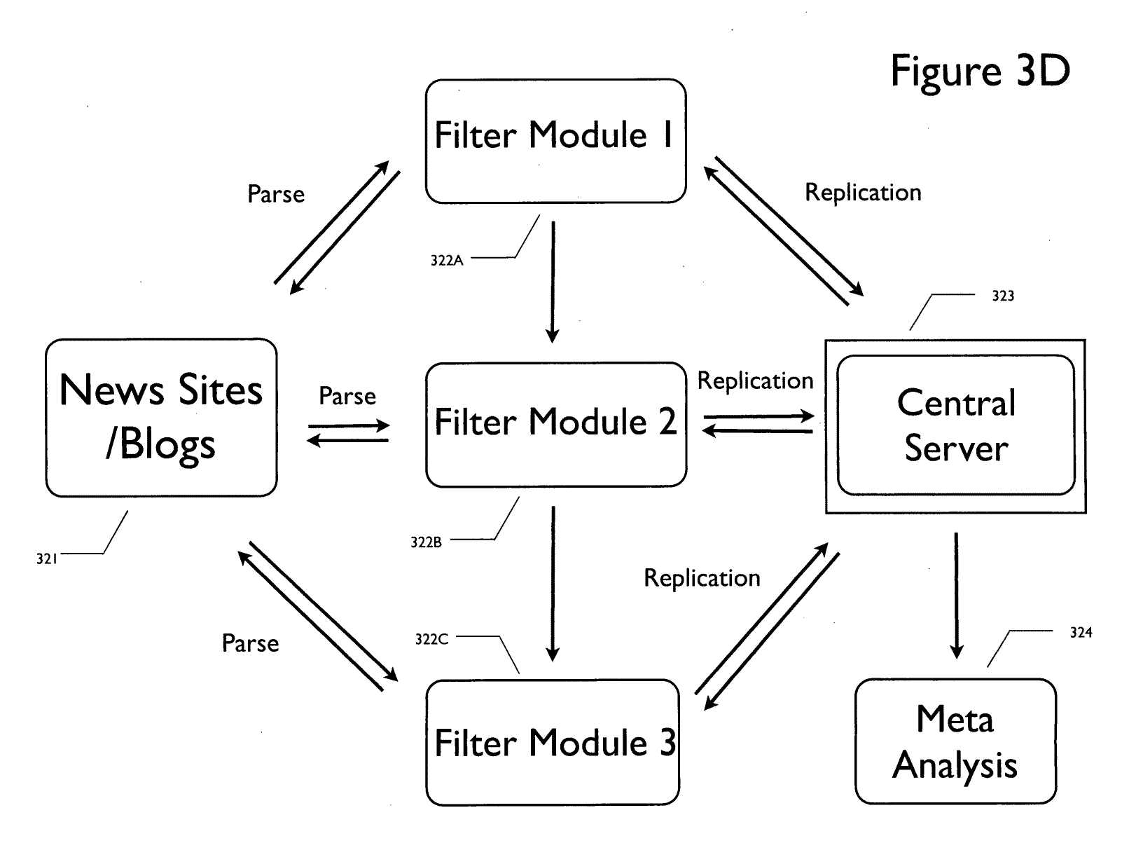

FIG. 3B illustrates the process of pulling key terms from news/blog sites with modular filters to produce quick data analysis.

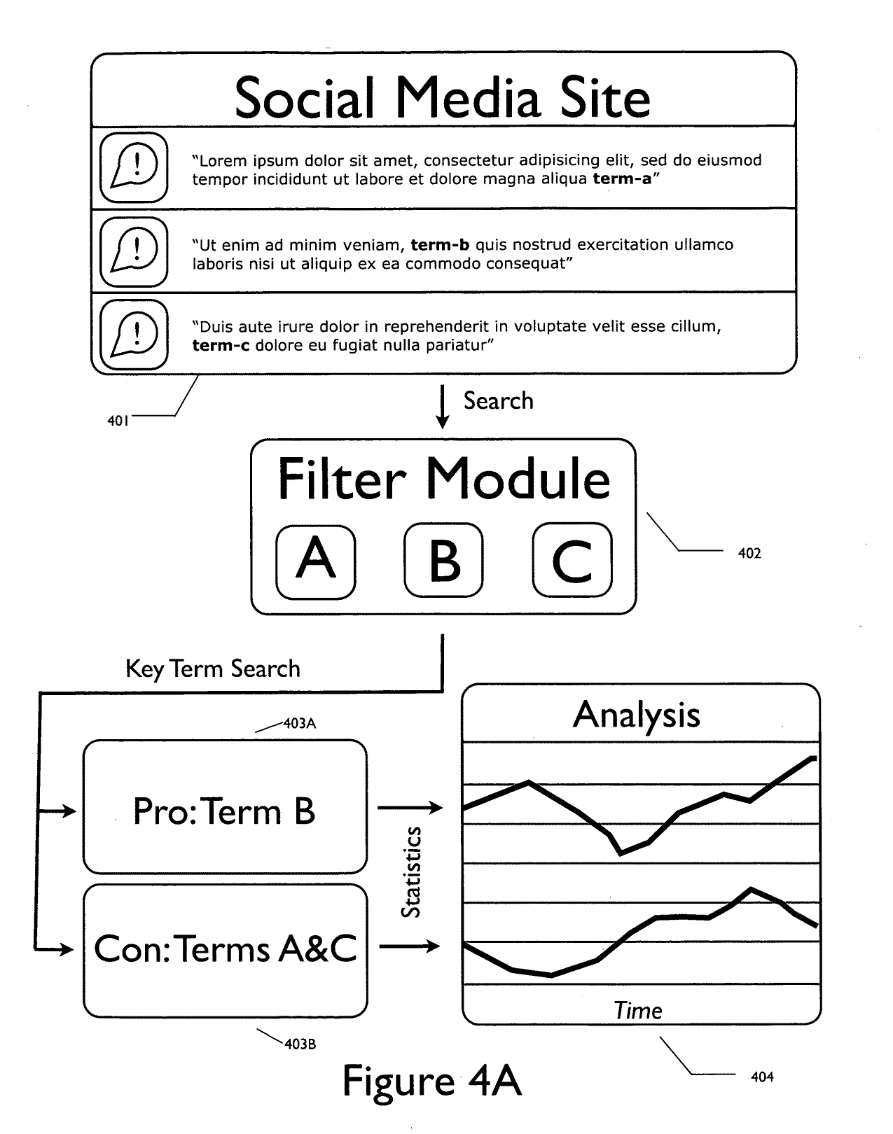

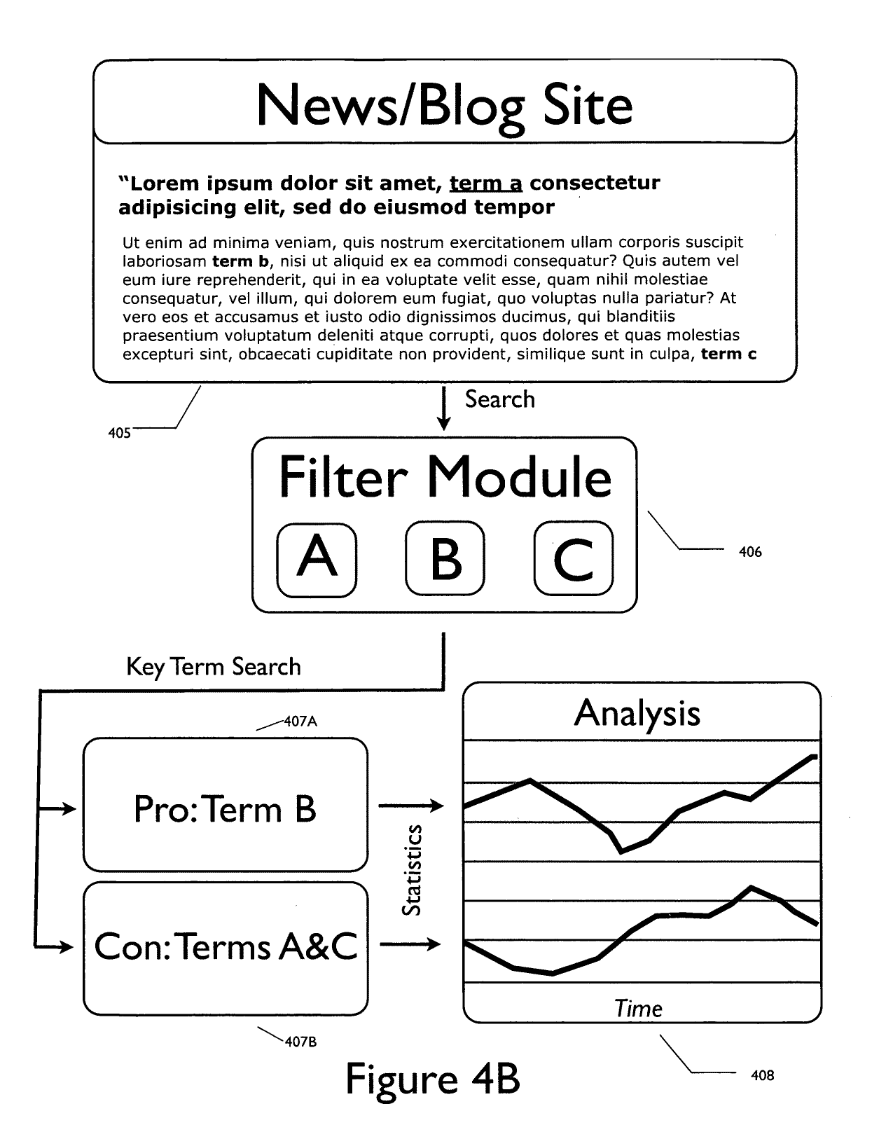

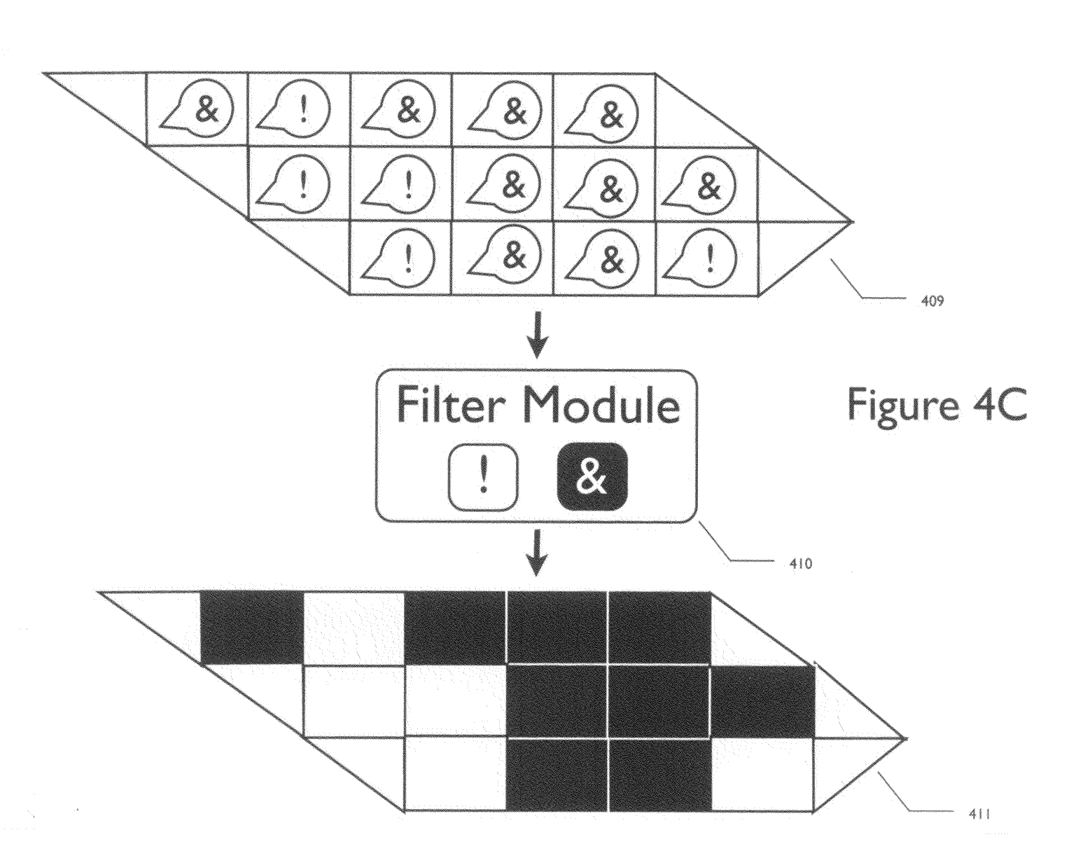

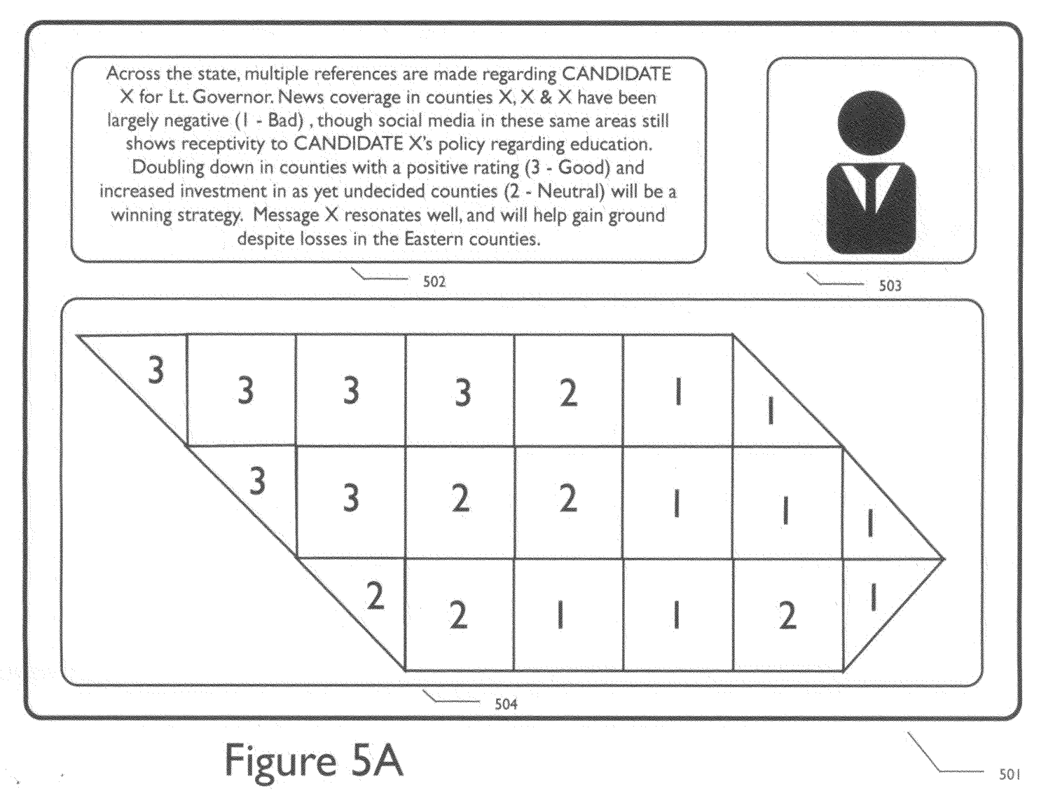

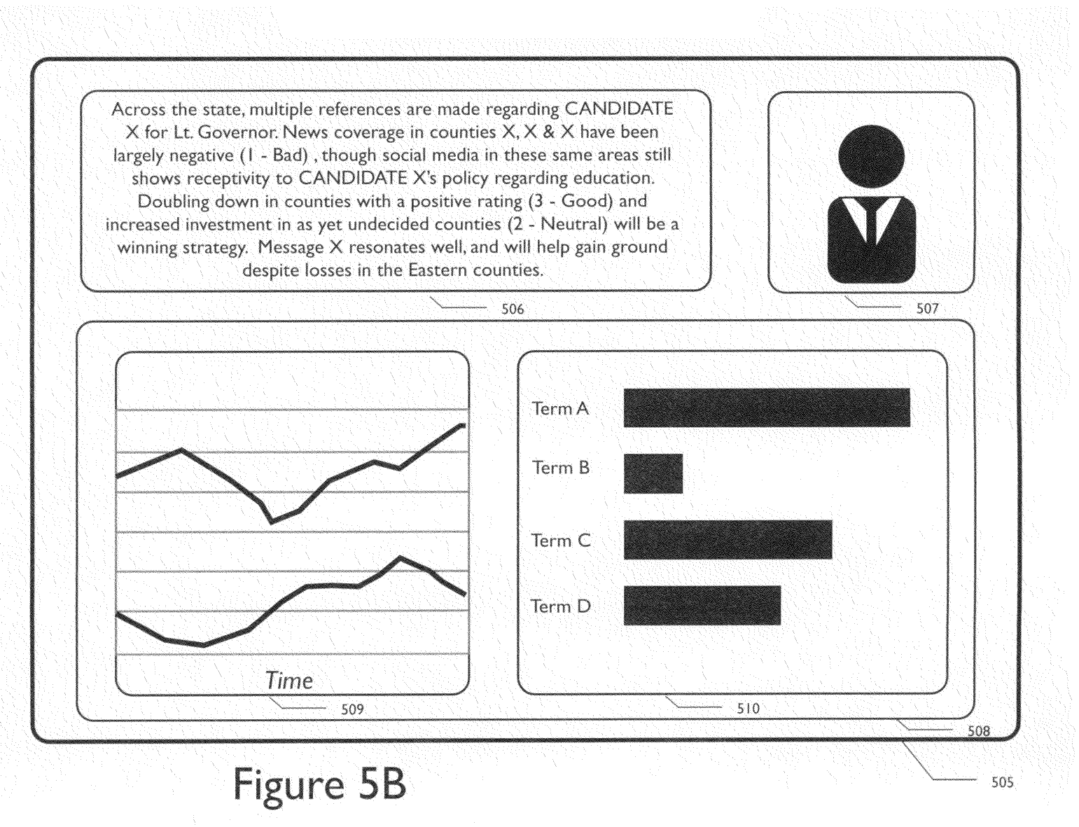

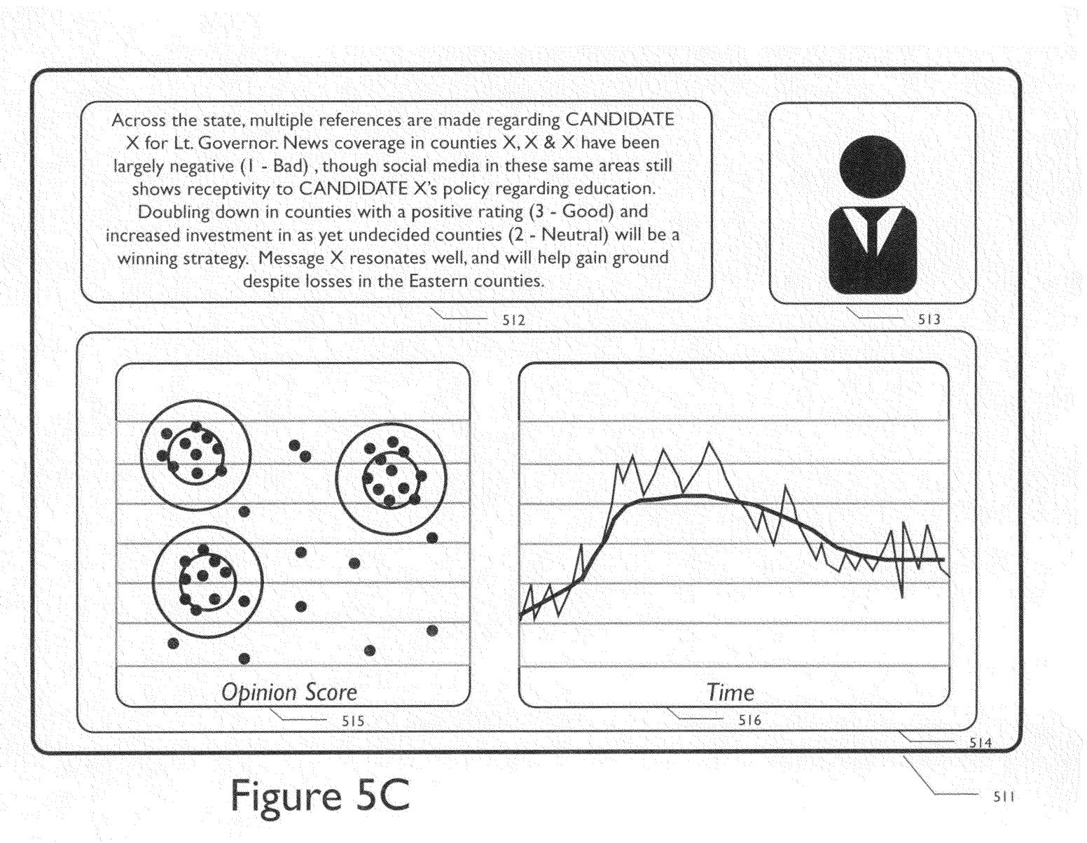

FIG. 4C illustrates the process of pulling key terms from geospatially distributed interne based text content and using modular filters to generate a geospatially relevant information map.

FIG. 5A illustrates one embodiment of web-based consulting, including summary text, a video recording of advice, and a geospatial information map.

FIG. 5B illustrates one embodiment of web-based consulting, including summary text, a video recording of advice, and embodiments of statistical data and relevant trends including time trend analysis and keyword frequency.

FIG. 5C illustrates one embodiment of web-based consulting, including summary text, a video recording of advice, and embodiments of statistical data and relevant trends including k-means cluster analysis and a moving average.

### 5. DETAILED DESCRIPTION OF THE INVENTION

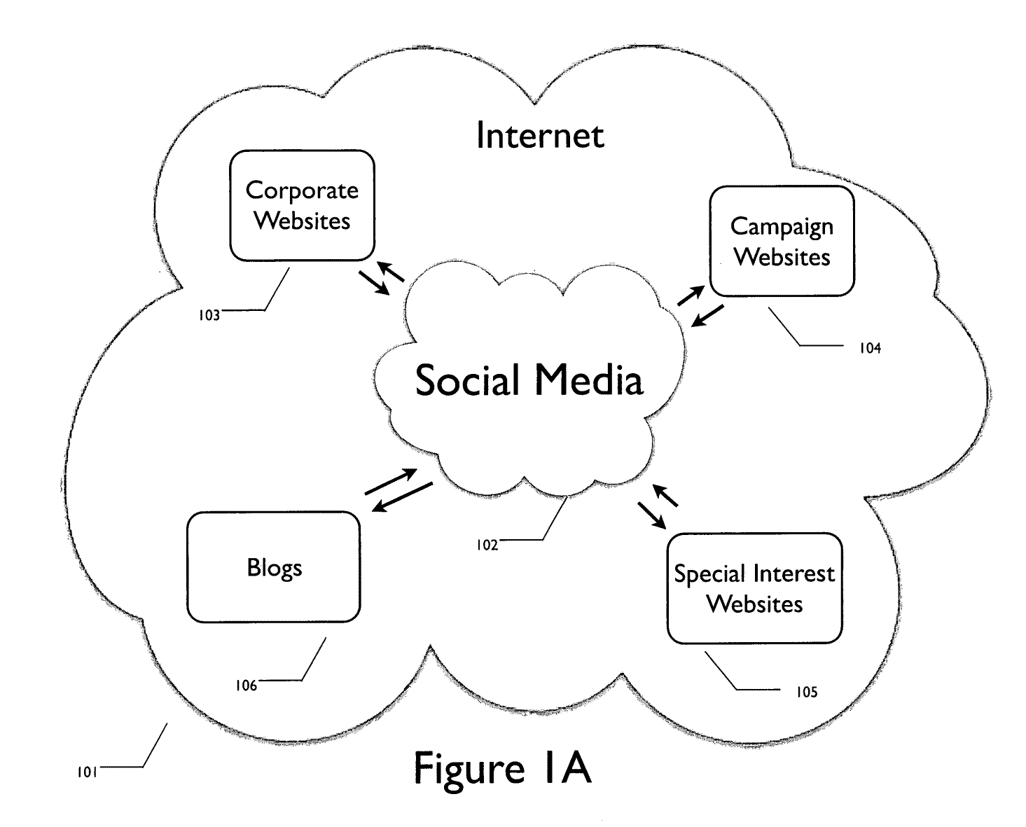

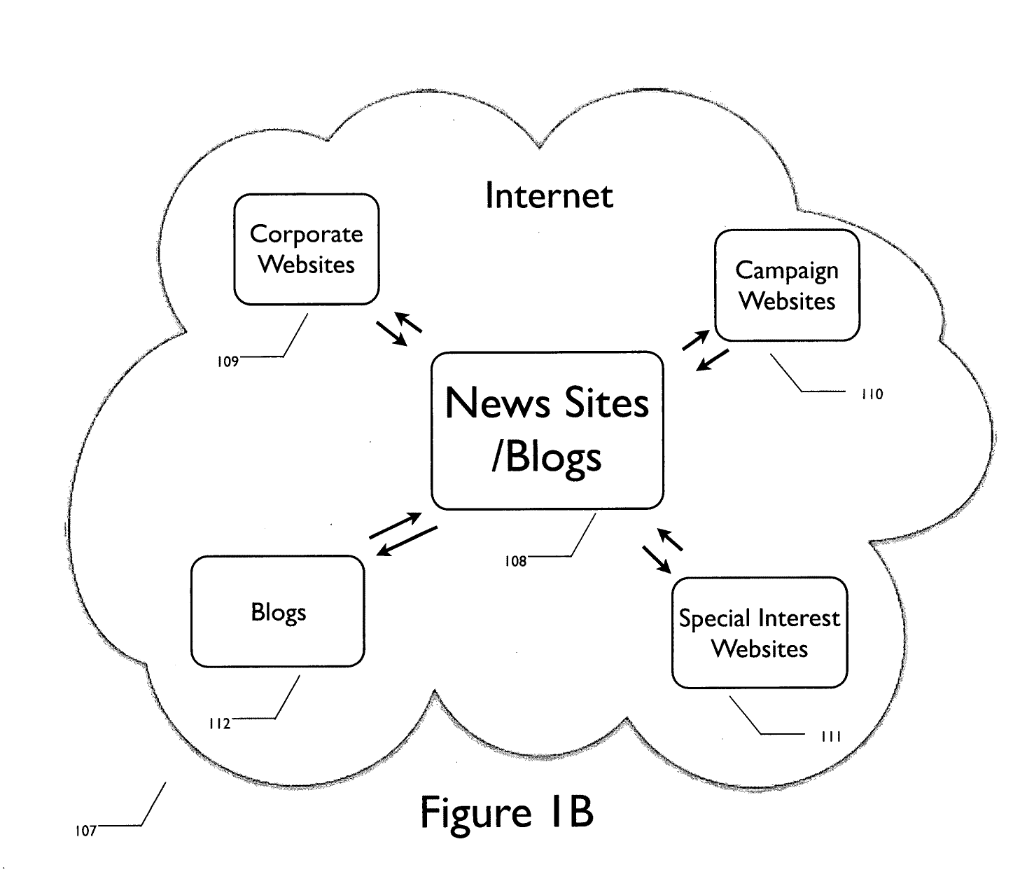

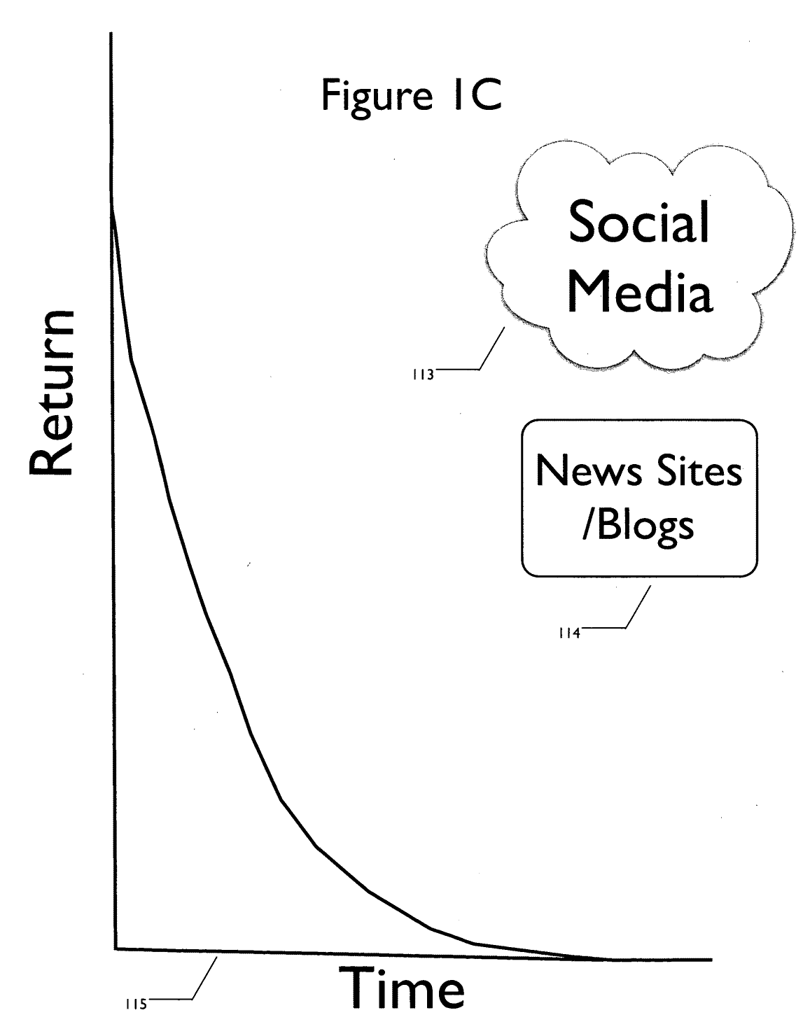

FIG. 1A is a representation of the relationship of social media 102 to the World Wide Web at large 101, including interactions with corporate websites 103, campaign websites 104, blogs 105, and special interest websites 106, to illustrate just a few examples.

FIG. 1B is a representation of the relationship of news and blog sites 108 to the World Wide Web at large 107, including interactions with corporate websites 109, campaign websites 110, other blogs 111, and special interest websites 112, to illustrate just a few examples.

FIG. 1C is an illustration of the investment trade off 115 when interacting with social media 113 and news media/blogs 114. As the time it takes to engage internet media increases, the return dramatically decreases.

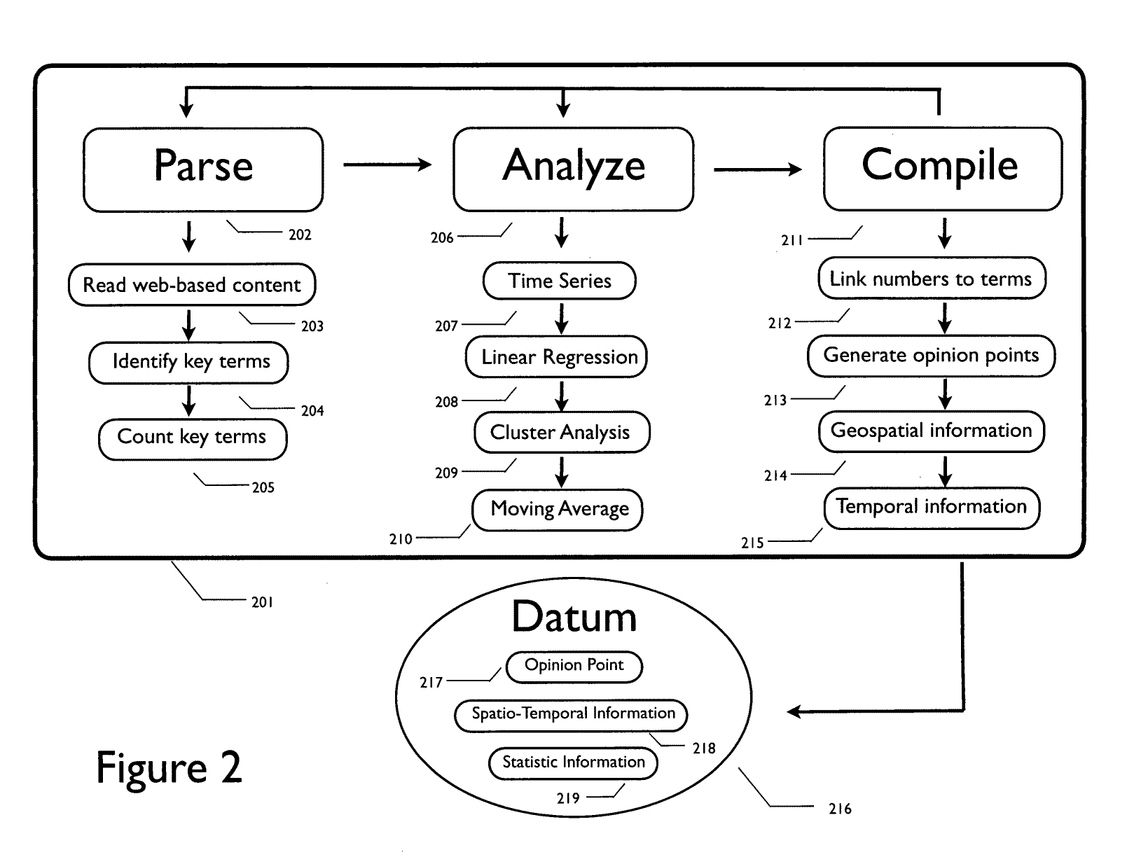

FIG. 2 is an illustration of the function of the filter module 201. Within the module 201, software parses 202 internet-based content and reads content 203, identified key terms 204, and counts those terms 205. It then analyses the data 206 with methods comprising; time series analysis 207, linear regression 208, cluster analysis 209, and a moving average 210, among other analytical methods. This data is then compiled 211 which comprises the steps of; linking numbers to terms 212, generating opinion points 213, tracking geospatial information 214, and identifying temporal information 215. This data is then wrapped and forms a synthetic datum 216 which may contain an opinion point 217, spatio-temporal information 218, and statistical information 219 when sufficient detail is pulled from the filter module 201. The process is able to be revised or reversed for a variety of reasons that may include errors, more optimal methods, and revisions.

FIG. 3A is an overview of one version of the program. The search page 302 of a social media website 301 produces basic search results 303 around a single term, from which a filter module 304 hosted at a central server 305 looks for a subset of key terms from the initial search results 303. Data is pulled regarding the occurrence of these key terms 306A-C, and these are compiled for analysis 307 at the same central server 305. These are then displayed graphically 308 along with output for the end user 309.

FIG. 3B illustrates the process in greater depth. A filter module 311A searches social media 310 and pulls relevant content first by searching a single key word, then by re-searching those results with a subset of other key words to assess tonality. The filer module 311A can be quickly replicated and modified (like a duplicated gene) to filter module 311B, which in turn interacts with social media 310. This can continue through 311C and other additional modified scripts. The modular nature of the software is housed at a central server 312, where modifications are made and re-made to suite the needs of different endusers.

This process can be done either manually or automatically using two files that output to each other as targets.

FIG. 3C illustrates another embodiment of the software. The home page 302 of a news or blog website 314 is parsed by a filter module 315 hosted at a central server 316 which parses the homepage for a subset of key terms developed to help categorize the data. Data is pulled regarding the occurrence of these key terms 317A-C, and these are compiled for analysis 318 at the same central server 316. These are then displayed graphically 319 along with output for the end user 320.

FIG. 3D looks more closely at what occurs with regard to news and blog sites. A filter module 322A searches news and blog sites 321 and pulls relevant content first by searching a single key word, then by re-searching those results with a subset of other key words to assess tonality. The filer module 322A can be quickly replicated and modified (like a duplicated gene) to filter module 322B, which in turn interacts with news and blog sites 321. This can continue through 322C and other additional modified scripts. The modular nature of the software is housed at a central server 323, where modifications are made and re-made to suite the needs of different end-users by providing analysis 324.

This process can be done either manually or automatically using two files that output to each other as targets.

FIG. 4A details the filter module's approach to social media. In one embodiment, the social media search results 401 are scanned by the filter module 402 for key terms. These are categorized by the filter module into pro 403A and con 403B data sets, which are process at regular time intervals to produce trends and other statistical analyses 404. Processes 402-403B occur in the filter module displayed in 304 and 311A-C.

For news and blog sites, the structure is similar. News and blog sites 405 are scanned by the filter module 406 for key terms. These are categorized by the filter module into pro 407A and con 407B data sets, which are process at regular time intervals to produce trends and other statistical analyses 408. Processes 406-407B occur in the filter module displayed in 315 and 317A-C.

FIG. 4C illustrates the translation of geospatially distributed data 409 to geospatially distributed information 411 through the use of the filter module 410. The location and time of a given piece of internet text content is taken by the filter module 410 as it assesses tonality. That geospatial and temporal information is recorded and bundled in a synthetic datum with the appropriate opinion information as detailed in FIG. 2 and then displayed in a geospatial manner that more simply illustrates the distribution of internet text content.

FIG. 5A illustrates one preferred embodiment of the distribution of the information processed by the filter module. On a computer via a web-based service 501 a short summary of the data processed that day 502 is displayed along with a video recording of analysis 503. Below is a geospatial map that displays the distribution of sentiment on a given set of specific issues. This may be displayed by a variety of methods such as topographic display, color representation, grayscale representation, and labels.

FIG. 5B illustrates one preferred embodiment of the distribution of information processed by the filter module. On a computer via a web-based service 505 a short summary of the data processed that day 506 is displayed along with a video recording of analysis 507. Below is a summary display of analysis 508 that comprises time trends 509 and keyword summary charts 510.

FIG. 5C illustrates one preferred embodiment of the distribution of information processed by the filter module. On a computer via a web-based service 511 a short summary of the data processed that day 512 is displayed along with a video recording of analysis 513. Below is a summary display of analysis 514 that comprises k-means cluster analysis 515 and a moving average 516.

The filter module can be easily targeted to a number of targets, including those that produce quicker and larger data sets for various interests who use the software. It's modular nature allows for quick replication and reuse in different contexts, allowing for a highly adaptable approach. The output is geared to make results clearly understandable through the process of categorization. This is demonstrated in FIGS. 4A, 4B, and 4C. The automated process over a period of time allows for comparable results so that the broader trends occurring in both social media and news/blog sites.

What is claimed is:

1. A modular filter method comprising the steps of: a filter adapted to infer tone from text gathered from websites; blogs; social media sites; and other internet-based content; records temporal and spatial information associated with text, assesses statistical significance, aggregates them in output; and allows for inference into the tone of the message (i.e. pro/con, liberal/conservative, humor/serious, etc.) and categorization into synthetic units that can be displayed either as charts or in a geospatial manner

2. The method of claim 1, wherein the step of arraying the software in a modular manner comprises at least one of: copying and modifying bits of the software in ad-hoc repetition to handle larger and larger data sets.

3. The method of claim 1, wherein the step of automatically gathering internet content comprises the step of pulling site URL from a central database stored on a computer hard drive.

4. The method of claim 1, wherein the step of automatically gathering internet content comprises at least one of: parsing select portions of web page/social media content for key terms.

5. The method of claim 1, wherein the step of inference into the tone of the message comprises a secondary; tertiary; etc. . . . ; search based on word association.

6. The method of claim 1, wherein the step of automatically aggregating web page/social media content comprises at least one of: printing output through an application interface that lists the key terms found and their respective quantities for each target URL.

7. The method of claim 1, wherein the step of assessing tonality of web page/social media content comprises at least one of: re-scanning the original output of the first scan for key terms that strongly indicate the opinion of the author based on word association.

8. The method of claim 1, wherein the step of automatically pulling the information into a file that can be further refined comprises at least one of: saving the text output in an easily stored and indexed format.

9. The method of claim 1, wherein the step of categorization of data into synthetic units comprises at least one of: a unit format that can be displayed graphically in a geospatial map, chart, or time trend.

10. A method of applying statistical analysis by using time depth, reference frequency, and advanced analysis identify patterns and meta-narratives to generate a system of mass content analysis.

11. The method of claim 10, wherein the step of applying statistical analysis comprises at least one of: quantification of qualitative data in preparation for advanced statistical analysis.

12. The method of claim 10, wherein the step of running advanced analysis comprises at least one of: cluster analysis; k-means cluster analysis; multilinear regression; nonlinear regression; multivariate analysis; moving average; and principle components analysis.

13. The method of claim 10, wherein the development of meta-narratives comprises at least one of: identification of patterns after multiple data sweeps by the modular filter to produced summary trend data.

14. The method of claim 10, wherein the step of using time depth comprises at least one of: identifying time and location data output from the modular filter.

15. The method of claim 10, wherein the step of identifying patterns and metanarratives comprises at least one of: quantitative analysis and qualitative analysis.

16. A method of distribution wherein the software is run from a central computer; scans websites and feeds based on keywords generated; and then the output is processed on a central CPU and distributed to third parties via a web application run off a separate CPU.

17. The method of claim 16, wherein the step of running the software from a central computer comprises at least one of: a central CPU and hard drive for storage of filter module output.

18. The method of claim 16, wherein the step of distributing processed output to third parties via a web application comprises at least one of: a separate CPU and hard drive storage system.

19. The method of claim 16, wherein the step of distributing information to third parties comprises at least one of: text; audio; and video content.

20. The method of claim 16, wherein the step of distributing information to third parties consists of displaying information comprises at least one of: charts; geospatial maps; time trends; and other visual representation.
